(19) United States
(12) Patent Application Publication
(10) Pub. No.: US 2025/0076498 A1
(43) Pub. Date: Mar. 6, 2025

(54) SYSTEMS, DEVICES, AND METHODS FOR DISPLAYING LIVE DATA

(71) Applicant: Navico, Inc., Tulsa, OK (US)

(72) Inventor: Aska Hiu Mei Lai, Auckland (NZ)

(21) Appl. No.: 18/457,614

(22) Filed: Aug. 29, 2023

(51) Int. Cl. G01S 15/89; G01S 7/56; G01S 13/89; G01S 15/96; G05D 1/02; G10K 11/00

(52) U.S. Cl. CPC G01S 15/89; G01S 7/56; G01S 13/89; G01S 15/96; G10K 11/008

(57) ABSTRACT

Example systems, devices, and methods are provided for causing displays on screens. Some such systems include a memory and a processor. The processor may be configured to cause display of a marine image formed from at least one of radar data or sonar data on a screen, receive live data including at least one of a live sonar feed or a live camera feed from a marine device, determine a location corresponding to the live data, determine a position within the marine image that represents the location, and cause display of the live data at the position on the screen such that the display of the live data overlays the position within the marine image.

### FIELD OF THE INVENTION

Example embodiments of the present invention generally relate to watercrafts and, more particularly to, systems, devices, and methods for displaying live data, such as a contextual overlay in other marine-based imagery.

### BACKGROUND

Marine images such as those displaying radar or sonar data may be difficult to decipher, particularly for novice users. For example, marine images containing radar data may only display general masses, and therefore while a flock of birds might be detectable, the radar data might not be able to easily convey to a user whether the birds in the flock are resting on the water or actively feeding on a school of fish. Such a distinction might be critical to a user trying to catch a fish. Similar problems occur with marine images containing sonar data because, e.g., sonar data can be irregular or hard to read. It would be desirable to provide for improvements in such and other situations.

### BRIEF SUMMARY

Current marine electronic devices and other systems display marine images containing data such as radar data and/or sonar data. However, in many situations, the data displayed in such marine images does not convey certain information and/or can be difficult to decipher, and, as such, a user might benefit from a different view of the environment being depicted by such marine images. Accordingly, some example embodiments of the present disclosure include systems, devices, and methods for displaying live data, e.g., as an overlay in such a marine image. As noted above, for example, a marine image containing radar data might display general masses indicating a flock of birds, but the marine image may not be able to convey to a user whether the flock of birds are resting on the water or actively feeding. The user might need to know the activity of the flock of birds in order to make critical decisions during activities such as fishing (e.g., should the user take the time and fuel to travel to the spot for potential fishing). The systems, devices, and methods of the present disclosure provide a marine device capable of obtaining live data of an overwater (e.g., on the water surface or in the air above the water surface) or underwater environment and then overlaying a display of the live data onto the marine image so that the user has more information about the relevant environment. For example, if the marine image conveys radar data indicating a flock of birds, the marine device might be an overwater drone capable of producing a live camera feed, and the system, device, and/or method may be configured to overlay a display of that live camera feed overtop the marine image of radar data, e.g., in an area representing the flock of birds.

As another example, in some embodiments, a marine image containing sonar data might display shapes indicating a school of fish. The user might need to know more about the school of fish in order to make critical decisions during activities such as fishing (e.g., should the user take the time and fuel to travel to the spot for potential fishing). The marine device might be an overwater and/or underwater drone capable of producing a live camera feed, and the system, device, and/or method may be configured to overlay a display of that live camera feed overtop the marine image of sonar data, e.g., in an area representing the school of fish.

In some embodiments, a processor may be configured to cause display of a marine image on a screen, such as of a marine electronic device, and the marine image may be formed from at least one of radar data or sonar data. The processor may also receive live data from a marine device. While the live data might be a live camera feed, as noted above, the live data might additionally or alternatively include a live sonar feed. The marine device could be a drone (e.g., an underwater drone, an overwater drone, or a drone that can travel both over water and underwater), a mobile device, or any other device such as one connected or mounted to a watercraft. The processor may determine a location corresponding to the live data, such as the geographic location of the flock of birds or the school of fish in the foregoing examples. The processor may also determine a position within the marine image that represents the location. For example, the position may be the general mass on the marine image indicating the flock of birds or the school of fish. The processor may then cause display of the live data at the position on the screen such that the display of live data overlays the position within the marine image.

In an example embodiment, a marine electronic device is provided. The marine electronic device includes a screen, a processor, and a memory including computer executable instructions, and the computer executable instructions are configured to, when executed by the processor, cause the processor to cause display of a marine image on the screen. The marine image is formed from at least one of radar data or sonar data. The computer executable instructions are also configured to, when executed by the processor, cause the processor to receive live data from a marine device. The live data includes at least one of a live sonar feed or a live camera feed. The computer executable instructions are also configured to, when executed by the processor, determine a location corresponding to the live data, determine a position within the marine image that represents the location, and cause display of the live data at the position on the screen such that the display of the live data overlays the position within the marine image.

In some embodiments, the display of the live data may be smaller than the marine image.

In some embodiments, the display of the live data may be moveable on the marine image, and the processor may be further configured to cause the marine device to move or adjust in response to a movement of the display of the live data on the marine image such that the position maintains a representation of the location corresponding to the live data.

In some embodiments, the processor may be configured to control an operation of the marine device based on the marine image so that the live data received from the marine device maintains a desired correspondence with the marine image.

In some embodiments, the marine image may be capable of being updated based on user input.

In some embodiments, the processor may be configured to cause the marine device to travel to a desired location.

In some embodiments, the location may be changeable independently of the processor, and the processor may be configured to, as the location changes, update the position and reposition the display of the live data on the screen such that the display of the live data overlays the position within the marine image.

In some embodiments, the marine image may provide a first viewpoint of an environment, and the live data may provide a second viewpoint of the environment.

In some embodiments, the live data may be related to but different from information displayed by the marine image.

In some embodiments, determining the location corresponding to the live data may include determining a geographic location of the marine device.

In some embodiments, determining the location corresponding to the live data may include approximating a geographic location of an object being depicted by the live data.

In some embodiments, the display of the live data may overlay the position within the marine image in a circular shape.

In some embodiments, a size of the display of the live data overlaying the position within the marine image may be less than 30 percent of a size of the marine image.

In some embodiments, the marine device may be a drone.

In some embodiments, the drone may be capable of traveling through at least one of an underwater environment or an overwater environment.

In some embodiments, the marine device may be a smartphone or a tablet.

In another example embodiment, a system is provided. The system includes a marine device, a screen, a processor, and a memory including computer executable instructions. The computer executable instructions are configured to, when executed by the processor, cause the processor to cause display of a marine image on the screen, and the marine image is formed from at least one of radar data or sonar data. The computer executable instructions are also configured to, when executed by the processor, receive live data from the marine device, and the live data includes at least one of a live sonar feed or a live camera feed. The computer executable instructions are also configured to, when executed by the processor, determine a location corresponding to the live data, determine a position within the marine image that represents the location, and cause display of the live data at the position on the screen such that the display of the live data overlays the position within the marine image.

In some embodiments, the display of the live data may be moveable on the marine image, and the processor may be further configured to cause the marine device to move or adjust in response to a movement of the display of the live data on the marine image such that the position maintains a representation of the location corresponding to the live data.

In some embodiments, the processor may be configured to control an operation of the marine device based on the marine image so that the live data received from the marine device maintains a desired correspondence with the marine image.

In another example embodiment, a method for causing a display on a screen is provided. The method includes causing display of a marine image on the screen, and the marine image is formed from at least one of radar data or sonar data. The method also includes receiving live data from a marine device, and the live data includes at least one of a live sonar feed or a live camera feed. The method also includes determining a location corresponding to the live data. determining a position within the marine image that represents the location, and causing display of the live data at the position on the screen such that the display of the live data overlays the position within the marine image.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows an example watercraft, in accordance with some embodiments described herein;

FIG. 2 shows a marine image formed from radar data, in accordance with some embodiments discussed herein;

FIG. 3A shows underwater live camera feed data, in accordance with some embodiments discussed herein;

FIG. 3B shows overwater live camera feed data, in accordance with some embodiments discussed herein;

FIG. 4 shows the marine image of FIG. 2 with a display of live data overlaid thereon, in accordance with some embodiments discussed herein;

FIG. 5A shows the marine image of FIGS. 2 and 4 with the display of live data of FIG. 4 overlaid thereon being moved by a user from a first position to a second position within the marine image, in accordance with some embodiments discussed herein;

FIG. 5B shows a marine device moving from a first location to a second location within an overwater environment, in accordance with some embodiments discussed herein;

FIG. 6 shows a side-by-side view of the marine image of FIGS. 2 and 4-5A and the live data of FIG. 5A, in accordance with some embodiments discussed herein;

FIG. 7A shows the marine image and overlaid live data of FIG. 4 on a screen of a mobile device, in accordance with some embodiments discussed herein;

FIG. 7B shows the marine image and overlaid live data of FIGS. 4 and 7A on a screen of a smartwatch, in accordance with some embodiments discussed herein;

FIG. 8 shows another marine image with another display of live data overlaid thereon, in accordance with some embodiments discussed herein;

FIG. 9A shows a marine device moving from a first location to a second location within an underwater environment, in accordance with some embodiments discussed herein;

FIG. 9B shows the marine image of FIG. 8 with the display of live data of FIG. 8 overlaid thereon being moved from a first position to a second position within the marine image, in accordance with some embodiments discussed herein;

FIG. 10 shows another marine image with another display of live data overlaid thereon, in accordance with some embodiments discussed herein;

FIG. 11A shows the marine image of FIG. 10 with the display of live data of FIG. 10 overlaid thereon being moved by a user from a first position to a second position within the marine image, in accordance with some embodiments discussed herein;

FIG. 11B shows another marine device moving from a first location to a second location within an underwater environment, in accordance with some embodiments discussed herein;

FIG. 12 is a block diagram of an example system, in accordance with some embodiments described herein; and

FIG. 13 shows an example method for causing a display on a screen, in accordance with some embodiments discussed herein.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout.

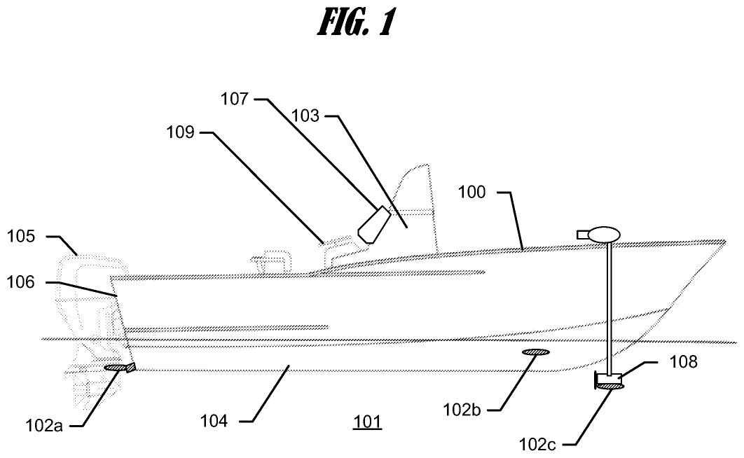

FIG. 1 shows a watercraft 100 (e.g., a vessel) configured to traverse a marine environment, e.g., body of water 101 (e.g., a portion of a hull 104 of the watercraft 100 is below the surface of the body of water 101). The watercraft 100 may be a surface watercraft, a submersible watercraft, or any other implementation known to those skilled in the art. The watercraft 100 may include one or more marine electronic devices 107, such as may be utilized by a user to interact with, view, or otherwise control various aspects of the watercraft and its various marine systems described herein. In the illustrated embodiment, the marine electronic device 107 is positioned proximate the helm (e.g., steering wheel 109) of the watercraft 100 on a console 103—although other places on the watercraft 100 are contemplated. Likewise, additionally or alternatively, a user's mobile device may include functionality of a marine electronic device.

Depending on the configuration, the watercraft 100 may include a main propulsion motor 105, such as an outboard or inboard motor. Additionally, the watercraft 100 may include a trolling motor 108 configured to propel the watercraft 100 or maintain a position. The motor 105 and/or the trolling motor 108 may be steerable using steering wheel 109, or in some embodiments, the watercraft 100 may have a navigation assembly that is operable to steer the motor 105 and/or the trolling motor 108. The navigation assembly may be connected to a processor and/or be within a marine electronic device 107, or it may be located anywhere else on the watercraft 100. Alternatively, it may be located remotely.

As depicted in FIG. 1, the watercraft 100 may use one or more sonar transducer assemblies 102a, 102b, and 102c disposed on and/or proximate to the watercraft. The transducer assemblies 102a, 102b, and 102c may each include one or more transducer elements (such as in the form of the arrays described herein) configured to transmit sound waves into a body of water, receive sonar returns from the body of water, and convert the sonar returns into sonar return data. The one or more transducer assemblies (e.g., 102a, 102b, and/or 102c) may be mounted in various positions and to various portions of the watercraft 100 and/or equipment associated with the watercraft 100. For example, the transducer assembly may be mounted to the transom 106 of the watercraft 100, such as depicted by transducer assembly 102a. The transducer assembly may be mounted to the bottom or side of the hull 104 of the watercraft 100, such as depicted by transducer assembly 102b. The transducer assembly may be mounted to the trolling motor 108, such as depicted by transducer assembly 102c. The transducer assembly may, in other embodiments, be mounted in any other position with respect to the watercraft 100.

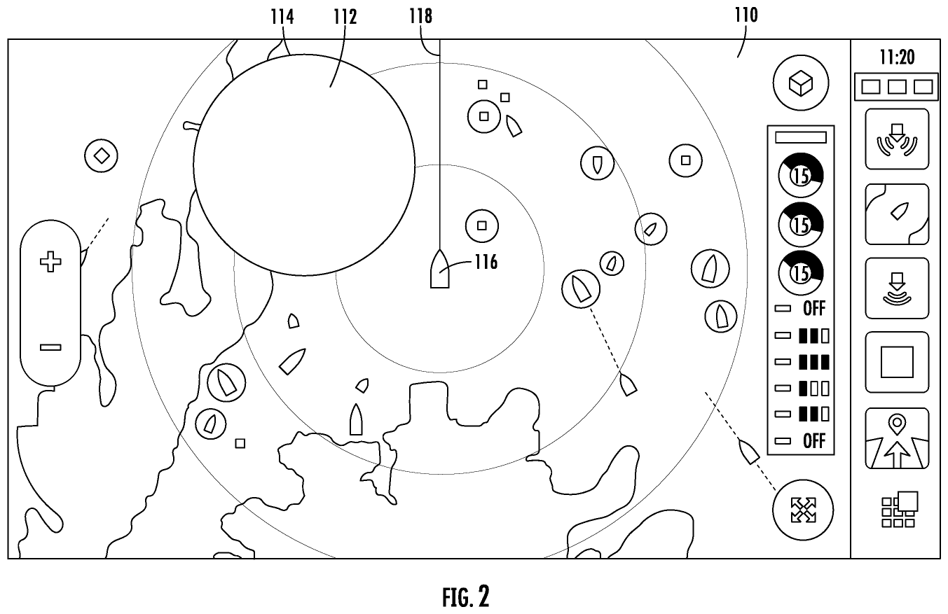

FIG. 2 shows an example marine image 110 that shows an icon 116 representing a watercraft traveling along a route 118 through a marine environment. The marine image 110 shown in FIG. 2 includes radar data, but it should be appreciated that, in other embodiments, the marine image 110 may include any other type of data, such as sonar data or chart data. The marine image 110 may be, in some embodiments, displayed on a screen of a marine electronic device (such as the marine electronic device 107 of FIG. 1). Further, the marine image 110 may or may not be interactive with a user.

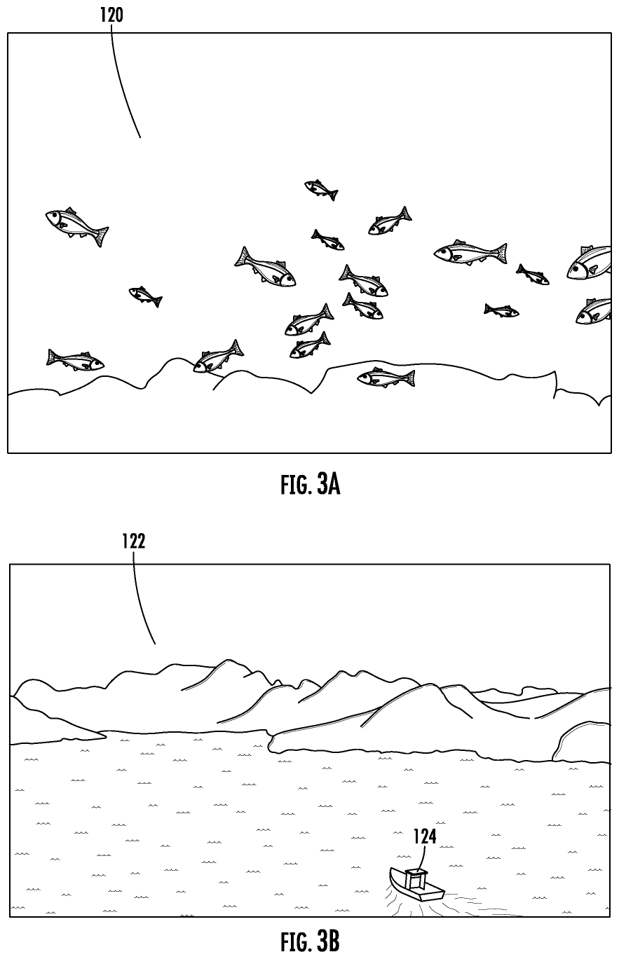

As shown by the circle 114 in FIG. 2, a user may be interested in obtaining additional data and/or information on a portion 112 of the marine image 110. For example, as shown in FIG. 3A, the user might want to view underwater live camera data 120 of the portion of the underwater environment represented by the portion 112 of the marine image 110 in FIG. 2. In the embodiment shown in FIG. 3A, the live camera data 120 shows a live view of fish. Alternatively, as shown in FIG. 3B, the user might want to view overwater live camera data 122 of the portion of the underwater environment represented by the portion 112 of the marine image 110 in FIG. 2. In the embodiment shown in FIG. 3B, the live camera data 122 shows a live view of watercraft 124. Such views might be obtainable from a marine device such as a drone (e.g., one that is capable of traveling through an underwater and/or overwater environment), mobile device (e.g., a smartphone or a tablet), or any other type of marine device. Notably, it might be cumbersome for the user to have to manually switch between views, and even if a user is able to switch between views, the user would have to manually navigate the marine device to the relevant location and then mentally decipher which parts of the image 120 or image 122 correlate to the portion 112 of the marine image 110 in FIG. 2.

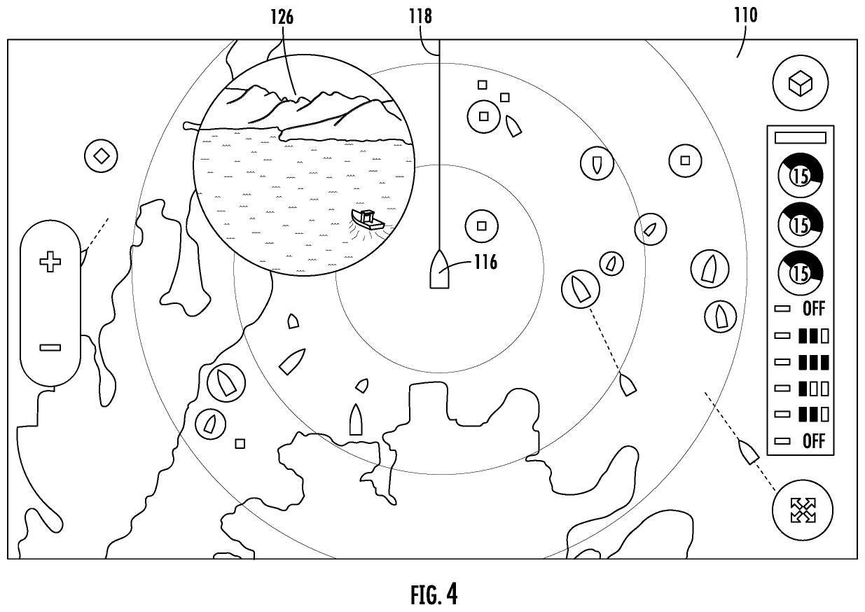

FIG. 4 shows the marine image 110 with live data 126 placed at the position 112 (shown in FIG. 2) such that the display of the live data 126 overlays the position 112 within the marine image 110. In the embodiment of FIG. 4, the display of live data 126 is smaller than the marine image 110, the display of live data 126 overlays the marine image 110 in a circular shape, and a size of the display of the live data 126 overlaying the marine image 110 is less than 30 percent of a size of the marine image 110. However, it should be appreciated that, in other embodiments, the live data 126 may be overlaid in any other size, shape, or way. For example, the live data 126 may be capable of being resized as needed (e.g., via a user pinching the live data 126 to shrink it, stretching the live data 126 to expand it, etc.). As shown, the display of the live data 126 overlaying the marine image 110 at the relevant position 112 enables the user to view two types of related data at the same time. That is, the live data 126 is related to but different from information displayed by the marine image 110, in that the marine image 110 provides a first viewpoint of an environment (e.g., a radar view), and the live data 126 provides a second viewpoint of the environment (e.g., a bird's eye camera view). It should be appreciated that, while the live data 126 shown in FIG. 4 is overwater live camera data, in some other embodiments, other live data such as underwater live camera data, live sonar data, or any other type of live data are also contemplated. Notably, in some embodiments, the user may toggle between the views (e.g., the overlay of the live data 126 may be toggled on and off).

In some embodiments, for example, a processor may be configured to cause display of the marine image 110 on a screen, and the marine image 110 may be formed from, e.g., radar data or sonar data. In the embodiment shown in FIG. 4, for example, the marine image 110 is formed from radar data. The processor may also be configured to receive the live data 126 from a marine device, and the live data may include, e.g., a live sonar feed or a live camera feed (among other forms of live data). In the embodiment shown in FIG. 4, for example, the live data 126 is a live camera feed of an overwater environment. The processor may also be configured to determine a location corresponding to the live data 126. For example, a processor may determine a geographic location of the marine device that is providing the live data 126 and/or may approximate a geographic location of an object being depicted by the live data 126. The processor may determine a position (such as the position 112 shown in FIG. 2) within the marine image 110 that represents the determined location and cause display of the live data 126 at the position 112 on the screen such that the display of the live data 126 overlays the position 112 within the marine image 110.

It should be appreciated that, although the marine image 110 includes radar data with live data 126 including live camera feed data overlaid thereon, in other embodiments, other types of data in the marine image 110 and in the live data 126 are contemplated. For example, a marine image including chart data, with live camera feed data overlaid thereon, may be especially usefully in situations in which charting was done a long time ago and thus is wildly inaccurate. Other configurations are also contemplated within the scope of this disclosure.

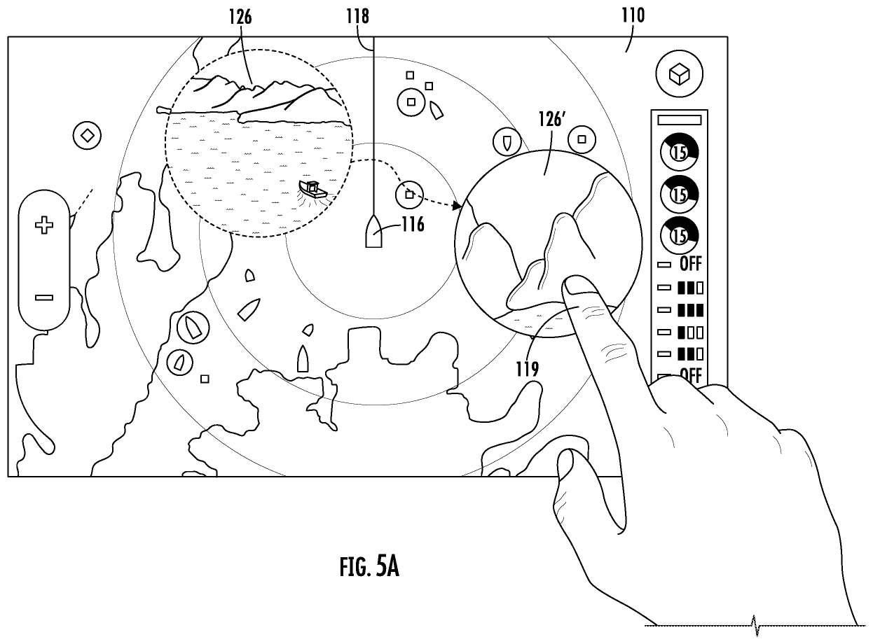

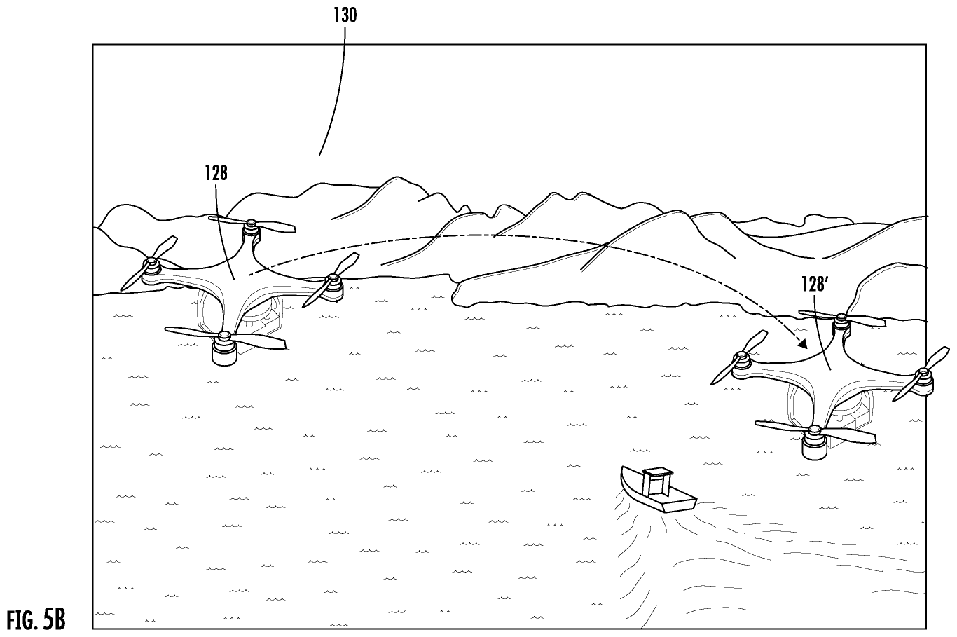

Referring now to FIGS. 5A-5B, the display of the live data 126 may be moveable on the marine image 110. In such embodiments, the processor may be configured to cause the marine device 128 (shown in FIG. 5B) to move in response to a movement of the display of the live data 126 on the marine image 110 such that the position maintains a representation of the location corresponding to the live data 126. As shown in FIG. 5A, the display of the live data 126 may be moved, e.g., by a user's finger 119 (or stylus, etc.) from a first position to a second position, as shown by the movement of the display of the live data 126 to the display of the live data 126′. Either as a cause of or a reaction to this, the marine device 128, as shown in FIG. 5B, may move from a first position to a second position, as shown by the movement of the marine device 128 to the marine device 128′ in the overwater environment 130. For example, a user viewing the marine image 110 with the display of live data 126 overlaid might decide that a different portion of the marine image 110 is of interest (e.g., the user might be interested in a different mass indicating a different flock of birds). The user may then drag the display of live data 126 such that it moves onto the position containing the different mass indicating the different flock of birds. The user's movement of the display of live data 126′ to the new position may cause the marine device 128 to move to a new geographic location (shown by marine device 128′) such that the live data being received from the marine device 128 maintains a desired correspondence with the marine image 110. That is, in the foregoing example, the user's movement of the display of live data 126′ to the new position causes the marine device 128′ to move to a geographic location that causes the display of live data 126′ to depict an overwater view of the different flock of birds that is of interest to the user. In this way, the marine image 110 is capable of being updated based on user input, and the processor is capable of causing the marine device 128 to travel to a desired location.

As another example, the marine image 110 comprising radar data may be used with the marine device 128 to perform search and rescue activities. That is, a user may be able to use the radar data in the marine image 110 to decide which masses necessitate a search and then direct the marine device 128 to those locations (instead of traveling to those locations with a watercraft). This may provide for a much quicker and more efficient rescue effort. Machine learning methods may also be used to conduct such activities. For example, machine learning methods may be used to interpret the radar data in the marine image 110 to determine where to send the marine device 128 to search, and then either a user or another machine learning method may be used to evaluate the display of live data 126 to determine whether, for example, an object of interest is located at the geographic location(s) of interest.

It should be appreciated that, while the marine image 110 comprising radar data may be used in some embodiments to perform search and rescue activities, in other embodiments, a marine image with chart data may be used to perform search and rescue activities. Additionally or alternatively, a marine image with AIS and/or man overboard data may also be used to perform search and rescue activities. Other configurations are also contemplated within the scope of this disclosure.

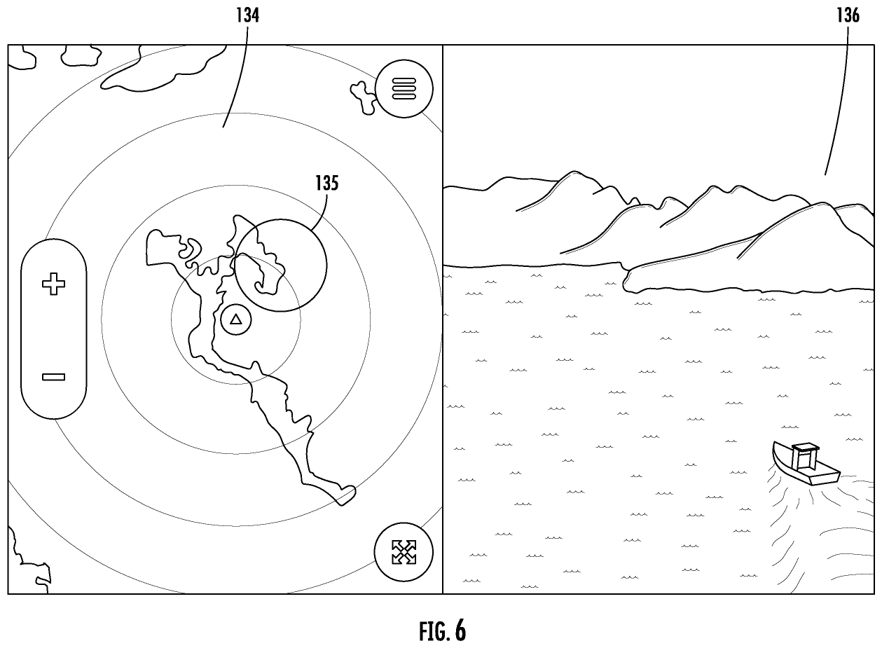

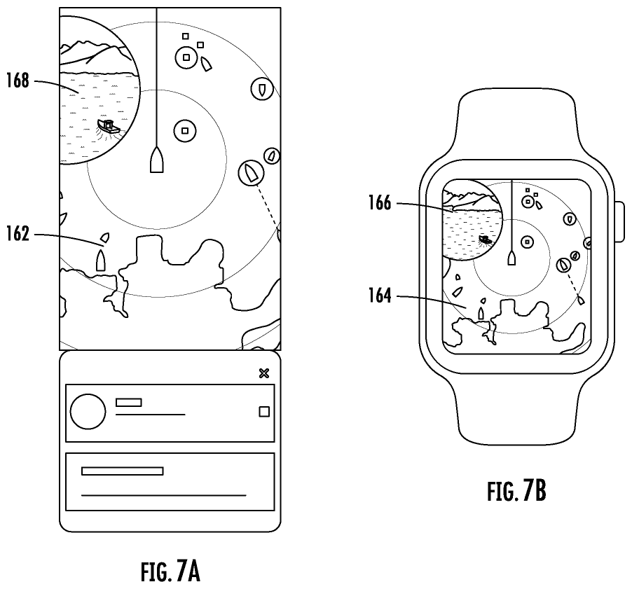

While the embodiments discussed with respect to FIGS. 4-5B show the display of the live data 126 overlaying the position within the marine image 110 in a circular shape, other configurations are also contemplated. For example, as shown in FIG. 6, the position may be called out by a circle (or other shape) 135, and the live data 136 may be displayed adjacent to or otherwise near the marine image 134. As another example, as shown by FIG. 7A, the display of live data 126 overlaid onto the marine image 110 from FIGS. 4-5B may be configured to be displayed on a screen of a smartphone such as shown by the display of live data 168 on the marine image 162. Similarly, as shown by FIG. 7B, the display of live data 126 overlaid onto the marine image 110 from FIGS. 4-5B may be configured to be displayed on a screen of a smartwatch such as shown by the display of live data 166 on the marine image 164. Further, it should also be appreciated that analytics and machine learning may be utilized to cause either the display of live data 126 to move across the marine image 110 and/or to cause the marine device 128 to move within the relevant environment. Other configurations are also contemplated.

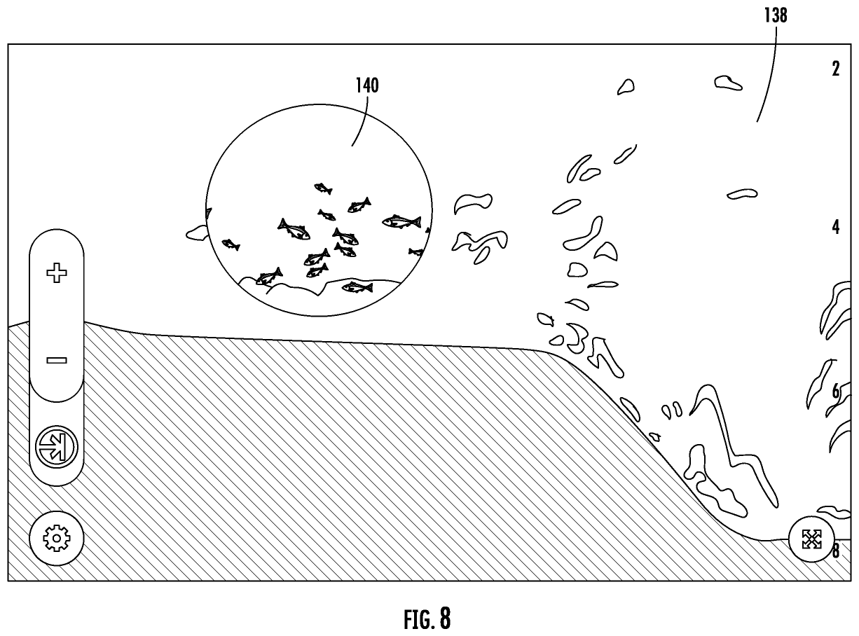

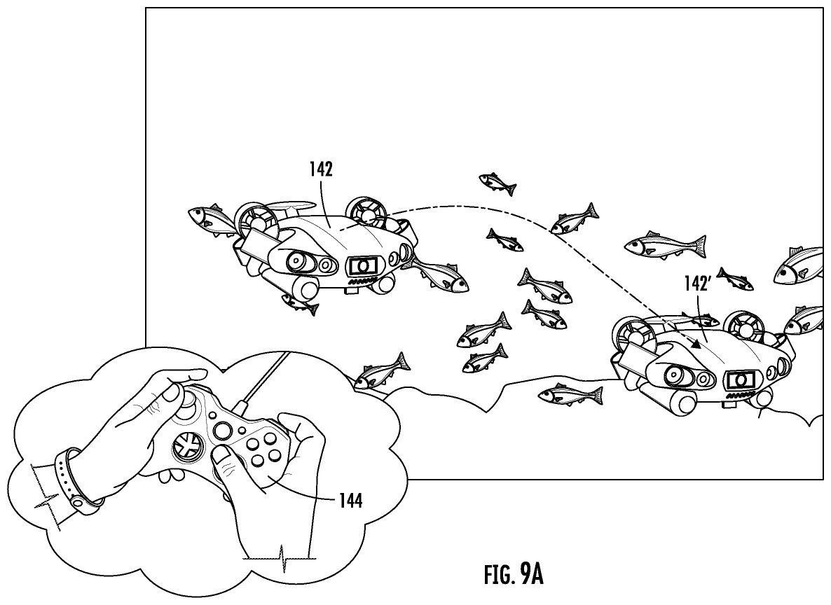

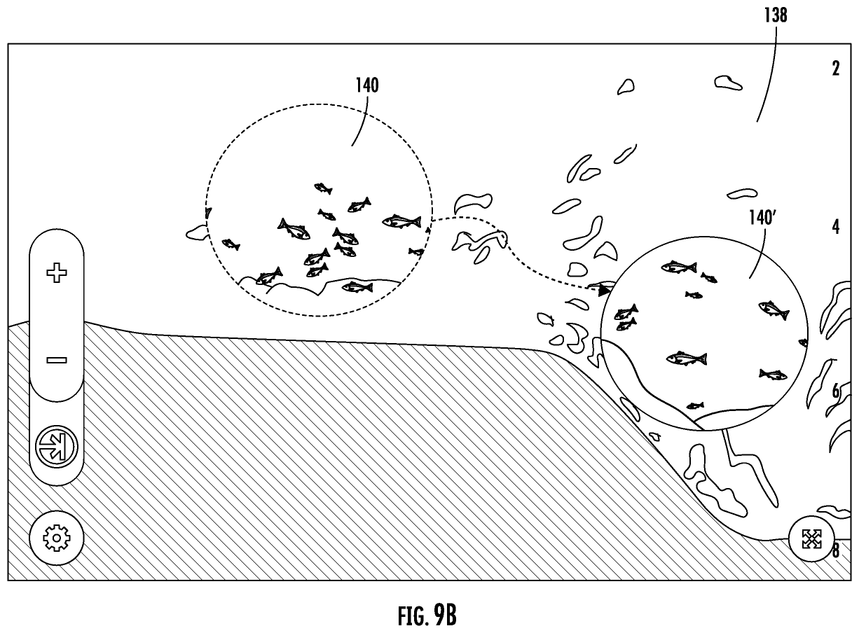

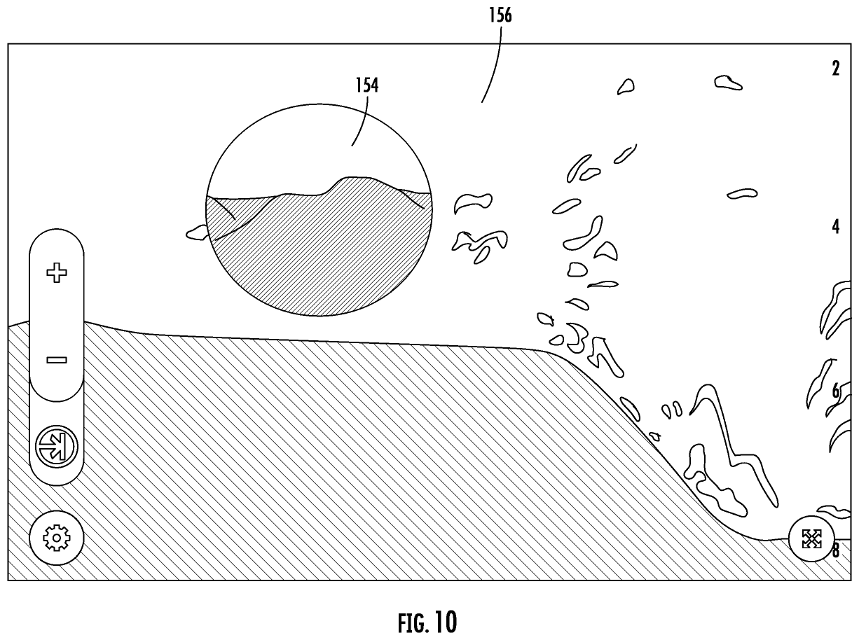

Referring now to FIGS. 8-9B, a marine image 138 may be formed of sonar data, and a marine device 142 (shown in FIG. 9A) may be capable of obtaining and/or transmitting underwater live camera data 140. As shown in FIG. 8, a display of the live data 140 may be overlaid on the marine image 138. The system and processor may be similar to the processor described above with respect to FIGS. 4-7B. However, as shown in FIG. 9A, the location of the marine device 142 may be able to be changed independently of the processor, e.g., through a remotely controlled device 144. Further, the processor may be configured to, as the location of the marine device 142 changes (e.g., to the location shown by marine device 142′), update the determined position and reposition the display of the live data 140 (e.g., to the position shown by display of the live data 140′) over the position on the screen such that the display of the live data overlays the position within the marine image 138, as shown in FIG. 9B. Thus, for example, a user might be viewing the marine image 138 with the display of live data 140 overlaid as shown in FIG. 8 and then decide to explore a different view of the underwater environment using the remotely controlled device 144 (FIG. 9A). As the user causes movement of the marine device 142 using the remotely controlled device 144 (e.g., to the location shown by marine device 142′ as shown in FIG. 9A), the display of the live data 140 may move to a new position overtop the marine image 138 (e.g., to the position shown by the display of the live data 140′ in FIG. 9B). This may allow the user to explore and view the underwater environment in different ways such that the user better understands the sonar data in the marine image 138 (among other things).

It should be appreciated that, although a remotely controlled device 142 may be used as described herein, it is not necessary. Further, the embodiment described with respect to FIGS. 8-9B may additionally or alternatively be configured such that a user can drag the display of live data 140 across the marine image 138 and cause automatic movement of the marine device 142 (e.g., by way of a processor), such as described above with respect to FIGS. 5A-5B. Other configurations are also contemplated. For example, some example embodiments contemplate using one or more sonar transducer assemblies or underwater live video cameras to provide the live data and, in some such embodiments, such assemblies or cameras may be adjustable in orientation such that even though they are mounted to the watercraft, they may still adjust the relative position of the live data being provided (such as useful in various embodiments described herein).

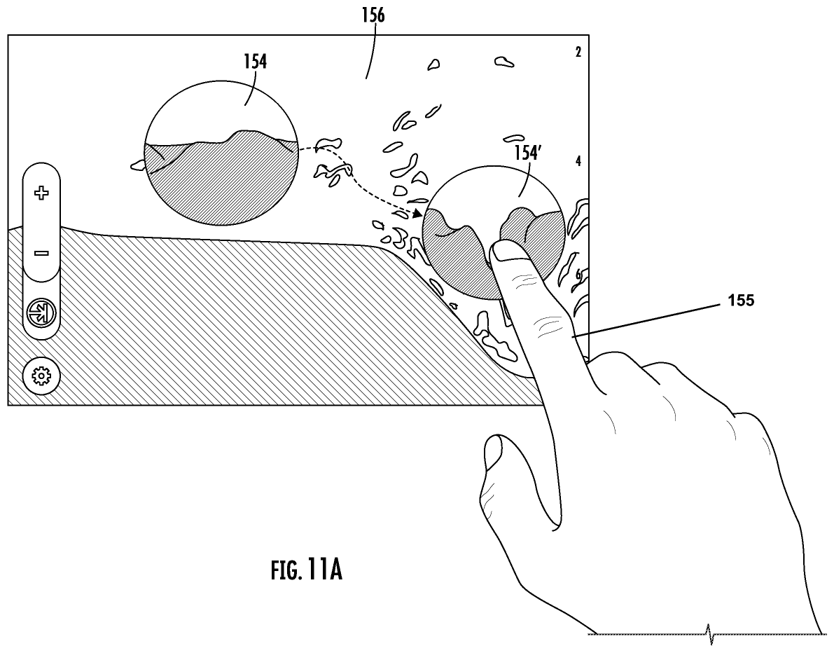

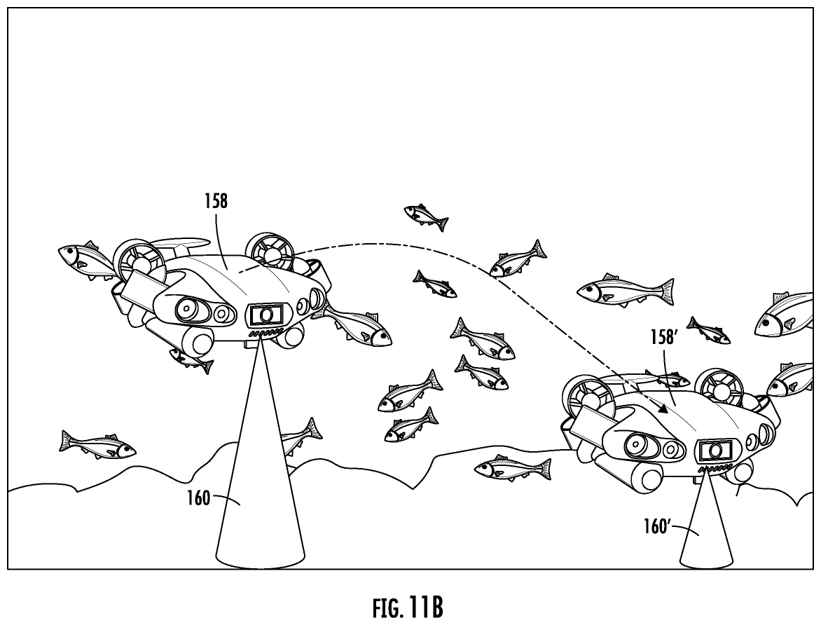

Referring now to FIGS. 10-11B, a marine image 156 may be formed of historical sonar data, and a marine device 158 (shown in FIG. 11B) may be capable of obtaining and/or transmitting live sonar data 154. As shown in FIG. 10, a display of the live data 154 may be overlaid on the marine image 156. The system and processor may be similar to the processors described above with respect to FIGS. 4-7B and/or FIGS. 8-9B. However, as shown in FIG. 11B, the marine device 158 may be equipped with one or more sonar transducer assemblies configured to emit one or more acoustic beams 160 into an underwater environment. The one or more sonar transducer assemblies may be further configured to, after emitting the one or more acoustic beams 160 into the underwater environment, receive sonar beams from the underwater environment and then, using a sonar signal processor in or on the marine device 158 and/or using a processor located elsewhere, the sonar return beams may be processed into live sonar data 154.

As described above with respect to FIGS. 4-7B and/or FIGS. 8-9B, the display of the live data 154 may be moveable on the marine image 156. In such embodiments, the processor may be configured to cause the marine device 158 (shown in FIG. 11B) to move in response to a movement of the display of the live data 154 on the marine image 156 such that the position maintains a representation of the location corresponding to the live data 154. As shown in FIG. 11A, the display of the live data 154 may be moved, for example, by a user's finger 155 (or stylus, etc.) from a first position to a second position, as shown by the movement of the display of the live data 154 to the display of the live data 154′. Either as a cause of or a reaction to this, the marine device 158, as shown in FIG. 5B, may move from a first position to a second position, as shown by the movement of the marine device 158 to the marine device 158′ in the underwater environment. For example, a user viewing the marine image 156 with the display of live data 154 overlaid might decide that a different portion of the marine image 156 is of interest (e.g., the user might be interested in a different portion of the historical sonar data). The user may then drag the display of live data 154 such that it moves onto the position containing the different historical sonar data.

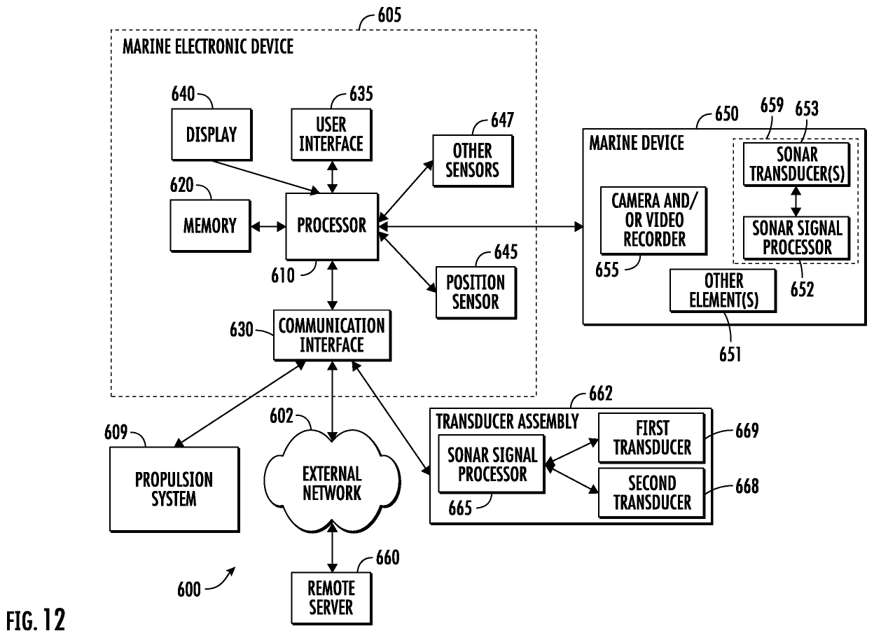

The user's movement of the display of live data 154′ to the new position may cause the marine device 158 to move to a new geographic location (shown by marine device 158′) such that the live data being received from the marine device 158 maintains a desired correspondence with the marine image 156. That is, in the foregoing example, the user's movement of the display of live data 154′ to the new position causes the marine device 158′ to move to a geographic location that causes the display of live data 154′ to depict an underwater view of the portion of the historical sonar data that is of interest to the user. Notably, in cases in which the marine image 156 contains historical sonar data, the historical sonar data may be created using a transducer assembly located on a watercraft (e.g., transducer assemblies 102a, 102b, and/or 102c in FIG. 1 and/or transducer assembly 662 in FIG. 12). The historical sonar data builds up from left to right in a “waterfall” format with each subsequent slice of sonar image portion filling on the right of the marine image 156 and pushing the older slices to the left (e.g., from sonar return data taken at different, older times). The processor may be configured to save in memory a geographic location of the watercraft at which each slice of sonar image portion is obtained, such that the processor can direct the marine device 158 to return to those geographic location(s) if/when the user drags the display of live data 154 over top of that slice of sonar image portion. For example, when the user moves the display of live data 154 to the position shown by the display of live data 154′, the processor may cause the marine device 158 to move to the geographic location in which the transducer assembly on the watercraft was located when the slice of sonar image portion underneath the display of live data 154′ was obtained. This may allow the user to view the live sonar data and the historical data at the same time, which can be especially useful for novice users who sometimes have difficulty understanding sonar data.

It should be appreciated that, although the historical sonar data may be obtained using a transducer assembly on a watercraft, as described above, in other embodiments, the historical sonar data may be obtained using a transducer assembly located elsewhere, such as on a second marine device. Further, while the marine device 158 is described as moving in response to a user dragging the display of live data 154 across the marine image 156, in some other embodiments, the marine device 158 may be movable independently such as described herein with respect to FIGS. 9A-9B. Other configurations are also contemplated.

### Example System Architecture

FIG. 12 shows a block diagram of an example sonar system 600 of various embodiments described herein. The illustrated sonar system 600 includes a marine electronic device 605, a transducer assembly 662, and a marine device 650, although other systems and devices may be included in various example systems described herein. In this regard, the system 600 may include any number of different systems, modules, or components; each of which may comprise any device or means embodied in either hardware, software, or a combination of hardware and software configured to perform one or more corresponding functions described herein.

The marine electronic device 605 may include a processor 610, a memory 620, a user interface 635, a display 640, one or more sensors (e.g., position sensor 645, other sensors 647, etc.), and a communication interface 630. One or more of the components of the marine electronic device 605 may be located within a housing or could be separated into multiple different housings (e.g., be remotely located).

The processor 610 may be any means configured to execute various programmed operations or instructions stored in a memory device (e.g., memory 620) such as a device or circuitry operating in accordance with software or otherwise embodied in hardware or a combination of hardware and software (e.g. a processor operating under software control or the processor embodied as an application specific integrated circuit (ASIC) or field programmable gate array (FPGA) specifically configured to perform the operations described herein, or a combination thereof) thereby configuring the device or circuitry to perform the corresponding functions of the processor 610 as described herein. In this regard, the processor 610 may be configured to analyze electrical signals communicated thereto to provide or receive sonar data, sensor data, location data, and/or additional environmental data. For example, the processor 610 may be configured to receive sonar return data, generate live sonar image data, and generate one or more live sonar images based on the live sonar image data. Further, the processor 610 may be configured to cause display of the live sonar data overlaying a marine image as described herein. In some embodiments, the processor 610 may additionally or alternatively be configured to do the same with live camera feed data.

In some embodiments, the processor 610 may be further configured to implement sonar signal processing, such as in the form of a sonar signal processor (although in some embodiments, portions of the processor 610 or the sonar signal processor could be located within the transducer assembly 662 and/or the marine device 650). In some embodiments, the processor 610 may be configured to perform enhancement features to improve the display characteristics or data or images, collect or process additional data, such as time, temperature, GPS information, waypoint designations, or others, or may filter extraneous data to better analyze the collected data. It may further implement notices and alarms, such as those determined or adjusted by a user, to reflect depth, presence of fish, proximity of other vehicles, e.g., watercraft, etc.

In an example embodiment, the memory 620 may include one or more non-transitory storage or memory devices such as, for example, volatile and/or non-volatile memory that may be either fixed or removable. The memory 620 may be configured to store instructions, computer program code, marine data, such as sonar data, chart data, location/position data, and other data associated with the navigation system in a non-transitory computer readable medium for use, such as by the processor for enabling the marine electronic device 605 to carry out various functions in accordance with example embodiments of the present disclosure. For example, the memory 620 could be configured to buffer input data for processing by the processor 610. Additionally, or alternatively, the memory 620 could be configured to store instructions for execution by the processor 610.

The communication interface 630 may be configured to enable connection to external systems (e.g., an external network 602). In this manner, the marine electronic device 605 may retrieve stored data from a remote device or remote server 660 via the external network 602 in addition to or as an alternative to the onboard memory 620. Additionally or alternatively, the marine electronic device 605 may transmit or receive data, such as sonar signals, sonar returns, sonar image data or the like to or from a transducer assembly 662. Further, the marine electronic device 605 may transmit or receive data, such as live feed data from a camera and/or video recorder 655, sonar signals, sonar returns, sonar image data or the like to or from a transducer assembly 659 (comprising sonar transducer(s) 653 and/or sonar signal processor 652). In some embodiments, the marine electronic device 605 may also be configured to communicate with other devices or systems (such as through the external network 602 or through other communication networks, such as described herein). For example, the marine electronic device 605 may communicate with a propulsion system of the watercraft (e.g., for autopilot control); a remote device (e.g., a user's mobile device, a handheld remote, etc.); or other system.

The marine electronic device 605 may also include one or more communications modules configured to communicate with one another in any of a number of different manners including, for example, via a network. In this regard, the communications module may include any of a number of different communication backbones or frameworks including, for example, Ethernet, the NMEA 2000 framework, GPS, cellular, WiFi, or other suitable networks. The network may also support other data sources, including GPS, autopilot, engine data, compass, radar, etc. In this regard, numerous other peripheral devices (including other marine electronic devices or transducer assemblies) may be included in the system 600.

The position sensor 645 may be configured to determine the current position and/or location of the marine electronic device 605 (and/or the watercraft 100). For example, the position sensor 645 may comprise a global positioning system (GPS), bottom contour, inertial navigation system, such as machined electromagnetic sensor (MEMS), a ring laser gyroscope, or other location detection system.

The display 640, e.g., one or more screens, may be configured to present images and may include or otherwise be in communication with a user interface 636 configured to receive input from a user. The display 640 may be, for example, a conventional LCD (liquid crystal display), a touch screen display, mobile device, or any other suitable display known in the art upon which images may be displayed.

In some embodiments, the display 640 may present one or more sets of marine data (or images generated from the one or more sets of data). Such marine data includes chart data, radar data, weather data, location data, position data, orientation data, sonar data, or any other type of information relevant to the watercraft. In some embodiments, the display 640 may be configured to present such marine data simultaneously as one or more layers or in split-screen mode, as described herein. In some embodiments, for example, one of the one or more layers might be obtained from the marine device 650, the transducer assembly 662, or any other marine device. In some embodiments, a user may select any of the possible combinations of the marine data for display.

In some further embodiments, various sets of data, referred to above, may be superimposed or overlaid onto one another. For example, a route may be applied to (or overlaid onto) a chart (e.g., a map or navigational chart). Additionally, or alternatively, depth information, weather information, radar information, sonar information, or any other navigation system inputs may be applied to one another. Further, data from one or more of the marine device 650 and/or the transducer assembly 662 may be overlaid onto a marine image of the marine electronic device 605 as described herein.

The user interface 636 may include, for example, a keyboard, keypad, function keys, mouse, scrolling device, input/output ports, touch screen, or any other mechanism by which a user may interface with the system.

Although the display 640 of FIG. 12 is shown as being directly connected to the processor 610 and within the marine electronic device 605, the display 640 could alternatively be remote from the processor 610 and/or marine electronic device 605. Likewise, in some embodiments, the position sensor 645 and/or user interface 635 could be remote from the marine electronic device 605.

The marine electronic device 605 may include one or more other sensors 647 configured to measure or sense various other conditions. The other sensors 647 may include, for example, an air temperature sensor, a water temperature sensor, a current sensor, a light sensor, a wind sensor, a speed sensor, or the like.

The transducer assembly 662 illustrated in FIG. 12 includes two transducer arrays 669 and 668. In some embodiments, more or less transducer arrays could be included, or other transducer elements could be included. As indicated herein, the transducer assembly 662 may also include a sonar signal processor 665 or other processor (although not shown) configured to perform various sonar processing. In some embodiments, the processor (e.g., processor 610 in the marine electronic device 605, the sonar signal processor 665 in the transducer assembly 662, or a remote processor—or combinations thereof) may be configured to filter sonar return data and/or selectively control transducer elements of the transducer arrays. For example, various processing devices (e.g., a multiplexer, a spectrum analyzer, A-to-D converter, etc.) may be utilized in controlling or filtering sonar return data and/or transmission of sonar signals from the arrays 669 and 668.

The transducer assembly 662 may also include one or more other systems, such as various sensor(s). For example, the transducer assembly 662 may include an orientation sensor, such as gyroscope or other orientation sensor (e.g., accelerometer, MEMS, etc.) that can be configured to determine the relative orientation of the transducer assembly 662 and/or the various arrays 669 and 668—such as with respect to a waterline, the top surface of the body of water, or other reference. In some embodiments, additionally or alternatively, other types of sensor(s) are contemplated, such as, for example, a water temperature sensor, a current sensor, a light sensor, a wind sensor, a speed sensor, or the like.

As noted, in some embodiments, the transducer assembly 662 may be adjustable in orientation to provide live data in different orientations relative to the watercraft. For example, one or more steering systems may be utilized. In some embodiments, the steering may occur by selecting portions of the live sonar imagery to correspond to the position within the marine image to which the overlay is applied.

The marine device illustrated in FIG. 12 may include a camera and/or video recorder 655, a transducer assembly 659 (comprising sonar transducer(s) 653 and/or sonar signal processor 652), along with other element(s) 651. As described herein, the marine device 650 may be an overwater and/or underwater drone, a mobile device, or any other marine device. The camera and/or video recorder may be configured to obtain and provide live camera feed data, e.g., to the processor 610 such that the live camera feed data can be displayed overlaying a marine image on the display 640. Similarly, the transducer assembly 659 may be configured to obtain and provide live sonar data, e.g., to the processor 610 such that the live sonar data can be displayed overlaying a marine image on the display 640. The other element(s) 651 may also be configured to provide other types of live data to the processor 610 and/or to support the camera and/or video recorder 655 and/or the transducer assembly 659.

### Example Flowchart(s)

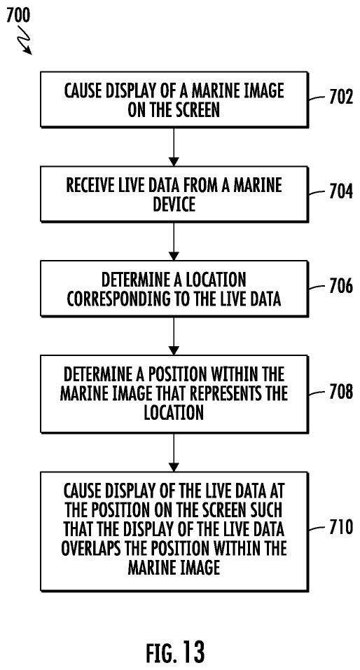

Embodiments of the present disclosure provide methods for causing a display on a screen. Various examples of the operations performed in accordance with embodiments of the present disclosure will now be provided with reference to FIG. 13.

FIG. 13 illustrates a flowchart according to an example method 700 for causing a display on a screen, according to various example embodiments described herein. The operations illustrated in and described with respect to FIG. 13 may, for example, be performed by, with the assistance of, and/or under the control of one or more of the components described herein, e.g., in relation to system 600.

Operation 702 may comprise causing display of a marine image on the screen. In some embodiments, the marine image may be formed from radar data and/or sonar data, among other types of data. The components discussed above with respect to system 600 may, for example, provide means for performing operation 702.

Operation 704 may comprise receiving live data from a marine device. In some embodiments, the live data may include a live sonar feed and/or a live camera feed. Further, in some embodiments, the marine device may be an overwater and/or underwater drone, a mobile device, or any other type of marine device, as described herein. The components discussed above with respect to system 600 may, for example, provide means for performing operation 704.

Operation 706 may comprise determining a location corresponding to the live data. In some embodiments, for example, operation 706 may include determining a geographic location corresponding to what the live data depicts and/or where the marine device is located. The components discussed above with respect to system 600 may, for example, provide means for performing operation 706.

Operation 708 may comprise determining a position within the marine image that represents the location. The components discussed above with respect to system 600 may, for example, provide means for performing operation 708.

Operation 710 may include causing display of the live data at the position on the screen such that the display of the live data overlays the position within the marine image. The components discussed above with respect to system 600 may, for example, provide means for performing operation 710.

FIG. 13 illustrates a flowchart of systems, methods, and/or computer program products according to example embodiments. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by, for example, the memory 620, and executed by, for example, the processor 610. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more non-transitory computer-readable mediums on which the computer program instructions may be stored such that the one or more computer-readable memories can direct a computer or other programmable device to cause a series of operations to be performed on the computer or other programmable apparatus to produce a computer-implemented process such that the instructions which execute on the computer or other programmable apparatus implement the functions specified in the flowchart block(s).

In some embodiments, the methods for causing displays on screens may include additional, optional operations, and/or the operations described above may be modified or augmented.

### CONCLUSION

Many modifications and other embodiments of the inventions set forth herein may come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A marine electronic device comprising:
a screen;
a processor; and
a memory including computer executable instructions, the computer executable instructions configured to, when executed by the processor, cause the processor to:
cause display of a marine image on the screen, wherein the marine image is formed from at least one of radar data or sonar data;
receive live data from a marine device, wherein the live data includes at least one of a live sonar feed or a live camera feed;
determine a location corresponding to the live data;
determine a position within the marine image that represents the location; and
cause display of the live data at the position on the screen such that the display of the live data overlays the position within the marine image.

2. The marine electronic device of claim 1, wherein the display of the live data is smaller than the marine image.

3. The marine electronic device of claim 1, wherein the display of the live data is moveable on the marine image, and wherein the processor is further configured to cause the marine device to move or adjust in response to a movement of the display of the live data on the marine image such that the position maintains a representation of the location corresponding to the live data.

4. The marine electronic device of claim 1, wherein the processor is configured to control an operation of the marine device based on the marine image so that the live data received from the marine device maintains a desired correspondence with the marine image.

5. The marine electronics device of claim 4, wherein the marine image is capable of being updated based on user input.

6. The marine electronic device of claim 4, wherein the processor is configured to cause the marine device to travel to a desired location.

7. The marine electronic device of claim 4, wherein the location can be changed independently of the processor, and wherein the processor is configured to, as the location changes, update the position and reposition the display of the live data on the screen such that the display of the live data overlays the position within the marine image.

8. The marine electronic device of claim 1, wherein the marine image provides a first viewpoint of an environment, and wherein the live data provides a second viewpoint of the environment.

9. The marine electronic device of claim 1, wherein the live data is related to but different from information displayed by the marine image.

10. The marine electronic device of claim 1, wherein determining the location corresponding to the live data comprises determining a geographic location of the marine device.

11. The marine electronic device of claim 1, wherein determining the location corresponding to the live data comprises approximating a geographic location of an object being depicted by the live data.

12. The marine electronic device of claim 1, wherein the display of the live data overlays the position within the marine image in a circular shape.

13. The marine electronic device of claim 1, wherein a size of the display of the live data overlaying the position within the marine image is less than 30 percent of a size of the marine image.

14. The marine electronic device of claim 1, wherein the marine device is a drone.

15. The marine electronic device of claim 14, wherein the drone is capable of traveling through at least one of an underwater environment or an overwater environment.

16. The marine electronic device of claim 1, wherein the marine device is a smartphone or a tablet.

17. A system comprising:
a marine device;
a screen;
a processor; and
a memory including computer executable instructions, the computer executable instructions configured to, when executed by the processor, cause the processor to:
cause display of a marine image on the screen, wherein the marine image is formed from at least one of radar data or sonar data;
receive live data from the marine device, wherein the live data includes at least one of a live sonar feed or a live camera feed;
determine a location corresponding to the live data;
determine a position within the marine image that represents the location; and
cause display of the live data at the position on the screen such that the display of the live data overlays the position within the marine image.

18. The system of claim 17, wherein the display of the live data is moveable on the marine image, and wherein the processor is further configured to cause the marine device to move or adjust in response to a movement of the display of the live data on the marine image such that the position maintains a representation of the location corresponding to the live data.

19. The system of claim 17, wherein the processor is configured to control an operation of the marine device based on the marine image so that the live data received from the marine device maintains a desired correspondence with the marine image.

20. A method for causing a display on a screen, the method comprising:
causing display of a marine image on the screen, wherein the marine image is formed from at least one of radar data or sonar data;
receiving live data from a marine device, wherein the live data includes at least one of a live sonar feed or a live camera feed;
determining a location corresponding to the live data;
determining a position within the marine image that represents the location; and
causing display of the live data at the position on the screen such that the display of the live data overlays the position within the marine image.
